(19) United States
(12) Patent Application Publication
(10) Pub. No.: US 2018/0305598 A1
(43) Pub. Date: Oct. 25, 2018

(54) ERUPTION MINIMIZATION IN THERMALLY STABLE PCD PRODUCTS

(71) Applicant: Smith International, Inc., Houston, TX (US)

(72) Inventors: Guojiang Fan, Salt Lake City, UT (US); Yahua Bao, Orem, UT (US); Jeffrey Bruce Lund, Salt Lake City, UT (US)

(21) Appl. No.: 15/770,805

(22) PCT Filed: Nov. 1, 2016
(86) PCT No.: PCT/US2016/059801

§ 371 Date: Apr. 25, 2018

Related U.S. Application Data
(60) Provisional application No. 62/248,520, filed on Oct. 30, 2015.

(51) Int. Cl. C09K 3/14; C01B 32/28; B24D 3/08; B24D 18/00; B24D 99/00; C22C 26/00; B22F 7/08; E21B 10/573

(52) U.S. Cl. CPC C09K 3/14; C01B 32/28; B24D 3/08; B24D 18/0009; B22F 2005/001; C22C 26/00; B22F 7/08; E21B 10/5735; B24D 99/005

(57) ABSTRACT

A polycrystalline diamond construction may be made by subjecting diamond grains to a high pressure/high temperature condition in the presence of a catalyst material to form a polycrystalline diamond material comprising a matrix phase of bonded together diamond grains and interstitial regions disposed between the diamond grains including the catalyst material, treating the polycrystalline diamond material to remove the catalyst material therefrom to form a diamond body that is substantially free of the catalyst material, and attaching a substrate to the diamond body with a layer of eruption minimization material having a thickness from about 2 μm to 8 μm on at least one attachment interface surface of the substrate and/or diamond body.

Polycrystalline diamond compact (“PDC”) cutters have been used in industrial applications including rock drilling and metal machining for many years. Generally a compact of polycrystalline diamond (PCD) (or other superhard material) is bonded to a substrate material, which is a sintered metal-carbide to form a cutting structure. PCD comprises a polycrystalline mass of diamonds (generally synthetic) that are bonded together to form an integral, tough, high-strength mass or lattice. The resulting PCD structure produces enhanced properties of wear resistance and hardness, making PCD materials extremely useful in aggressive wear and cutting applications where high levels of wear resistance and hardness are desired.

A PDC cutter may be formed by placing a cemented carbide substrate into the container of a press. A mixture of diamond grains or diamond grains and catalyst binder is placed atop the substrate and treated under high pressure, high temperature conditions. In doing so, metal binder (often cobalt) migrates from the substrate and passes through the diamond grains to promote intergrowth between the diamond grains. As a result, the diamond grains become bonded to each other to form the diamond layer, and the diamond layer is in turn bonded to the substrate. The substrate often comprises a metal-carbide composite material, such as tungsten carbide. The deposited diamond layer is often referred to as the “diamond table” or “abrasive layer.”

Conventional PCD includes 85-95% by volume diamond and a balance of the binder material, which is present in PCD within the interstices existing between the bonded diamond grains. Binder materials that are generally used in forming PCD include Group VIII elements, with cobalt (Co) being the most common binder material used.

An example of a rock bit for earth formation drilling using PDC cutters is shown in FIG. 1. FIG. 1 shows a rotary drill bit 10 having a bit body 12. The lower face of the bit body 12 is formed with a plurality of blades 14, which extend generally outwardly away from a central longitudinal axis of rotation 16 of the drill bit. A plurality of PDC cutters 18 are disposed side by side along the length of each blade. The number of PDC cutters 18 carried by each blade may vary. The PDC cutters 18 are individually brazed and are received and secured within sockets in the respective blade.

A factor in determining the longevity of PDC cutters is the generation of heat at the cutter contact point, specifically at the exposed part of the PDC layer caused by friction between the PCD and the work material. This heat causes thermal damage to the PCD in the form of cracks (due to differences in thermal expansion coefficients) which lead to spalling of the polycrystalline diamond layer, delamination between the polycrystalline diamond and substrate, and back conversion of the diamond to graphite causing rapid abrasive wear. The thermal operating range of conventional PDC cutters is generally 750° C. or less.

As mentioned, conventional polycrystalline diamond is stable at temperatures of up to 700-750° C., after which observed increases in temperature may result in permanent damage to and structural failure of polycrystalline diamond. This deterioration in polycrystalline diamond may be due to the difference in the coefficient of thermal expansion of the binder material, cobalt, as compared to diamond. Upon heating of polycrystalline diamond, the cobalt and the diamond lattice will expand at different rates, which may cause cracks to form in the diamond lattice structure and result in deterioration of the polycrystalline diamond. Damage may also be due to graphite formation at diamond-diamond necks leading to loss of microstructural integrity and strength loss.

In order to overcome this problem, strong acids may be used to “leach” the cobalt from the diamond lattice structure (either a thin volume or the entire tablet) to at least reduce the damage experienced from heating diamond-cobalt composite at different rates. Briefly, a strong acid, such as nitric acid or combinations of several strong acids (such as nitric and hydrofluoric acid) may be used to treat the diamond table, removing at least a portion of the catalyst from the PCD composite. By leaching out the cobalt, thermally stable polycrystalline (TSP) diamond may be formed. In certain embodiments, a select (less than all) portion of a diamond composite is leached, in order to gain thermal stability without losing impact resistance. As used herein, the term TSP includes both of the above (i.e., partially and completely leached) compounds. Interstitial volumes remaining after leaching may be reduced by either furthering consolidation or by filling the volume with a secondary material.

However, it is highly undesirable for the substrate of a cutting element comprising a PCD cutting table to be exposed to the leaching solution. Exposure of the substrate to the leaching solution can weaken both the structural integrity of the substrate itself, along with the interfacial bond attaching the PCD cutting table to the substrate. This vulnerability has led to leaching processes being performed with unattached PCD cutting tables, which then require attachment/re-attachment to a substrate via brazing or high-temperature high-pressure (HTHP) sintering

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for making a polycrystalline diamond construction including subjecting diamond grains to a high pressure/high temperature condition in the presence of a catalyst material to form a polycrystalline diamond material comprising a matrix phase of bonded together diamond grains and interstitial regions disposed between the diamond grains including the catalyst material, treating the polycrystalline diamond material to remove the catalyst material therefrom to form a diamond body that is substantially free of the catalyst material, and attaching a substrate to the diamond body with a layer of eruption minimization material having a thickness from about 2 μm to 8 μm on at least one attachment interface surface of the substrate and/or diamond body. In an embodiment, the eruption minimization material comprises a composition including at least one metal, carbide, nitride, or carbonitride compound of an element from Group 4-6 of the Periodic Table of the Elements. In an embodiment, the eruption minimization material is disposed on the attachment interface surface of the substrate. In an embodiment, the eruption minimization material is disposed on at least one attachment interface surface by one of sputter coating, application of a foil, application of a layer of powder, application of a layer of paste, casting, brushing, spraying, chemical vapor deposition, or physical vapor deposition. In an embodiment, the thickness of the eruption minimization material disposed on at least one attachment interface surface is from about 2 μm to 4 μm. In an embodiment, the polycrystalline diamond material is formed unattached to a substrate. In an embodiment, the attaching comprises an infiltration process.

In another aspect, a polycrystalline diamond construction includes a substrate, a thermally stable diamond body with at least some of the interstitial regions within the diamond body and near an attachment interface with the substrate possessing an infiltrant that is not the catalyst material used to form the diamond body, and a layer of eruption minimization material having a thickness from about 2 μm to 8 μm disposed at the attachment interface surface between the diamond body and the substrate. In an embodiment, the eruption minimization material comprises a composition including at least one metal, carbide, nitride, or carbonitride compound of an element from Group 4-6 of the Periodic Table of the Elements. In an embodiment, the thickness of the eruption minimization material is from about 2 μm to 4 μm.

In another aspect, a method for making a thermally stable polycrystalline diamond construction includes disposing a layer of eruption minimization having a thickness from about 2 μm to 8 μm material on an attachment interface surface of either a substrate or a thermally stable diamond body that has had the catalyst material removed therefrom, aligning the attachment interface surface of the substrate or the thermally stable diamond body to be adjacent to the attachment interface surface with the eruption minimization material disposed thereon, and attaching the substrate to the thermally stable diamond body with a high temperature high pressure treatment. In an embodiment, the eruption minimization material comprises a composition including at least one metal, carbide, nitride, or carbonitride compound of an element from Group 4-6 of the Periodic Table of the Elements. In an embodiment, the eruption minimization material is disposed on the attachment interface surface of the substrate. In an embodiment, the eruption minimization material is disposed on at least one attachment interface surface by one of sputter coating, application of a foil, application of a layer of powder, application of a layer of paste, casting, brushing, spraying, chemical vapor deposition, or physical vapor deposition. In an embodiment, the thickness of the eruption minimization material disposed on at least one attachment interface surface is from about 2 μm to 4 μm. In an embodiment, the attaching comprises an infiltration process.

Other aspects and advantages of the claimed subject matter will be apparent from the following description and the appended claims.

### BRIEF DESCRIPTION OF DRAWINGS

FIG. 1 is an illustration of a PDC drill bit.

FIG. 2 is a visualization of eruptions from a carbide substrate that form during the attachment of a carbide substrate to a leached diamond body via an infiltration process.

FIG. 3 is a visualization showing no eruptions in a carbide substrate that has been coated by an eruption minimization material prior to the attachment of the carbide substrate to a leached diamond body via an infiltration process.

FIG. 4 is a cross-sectional view of a conventionally formed reattached thermally stable diamond compact.

FIG. 5 is a cross-sectional view of a reattached thermally stable diamond compact formed using methods of the present disclosure.

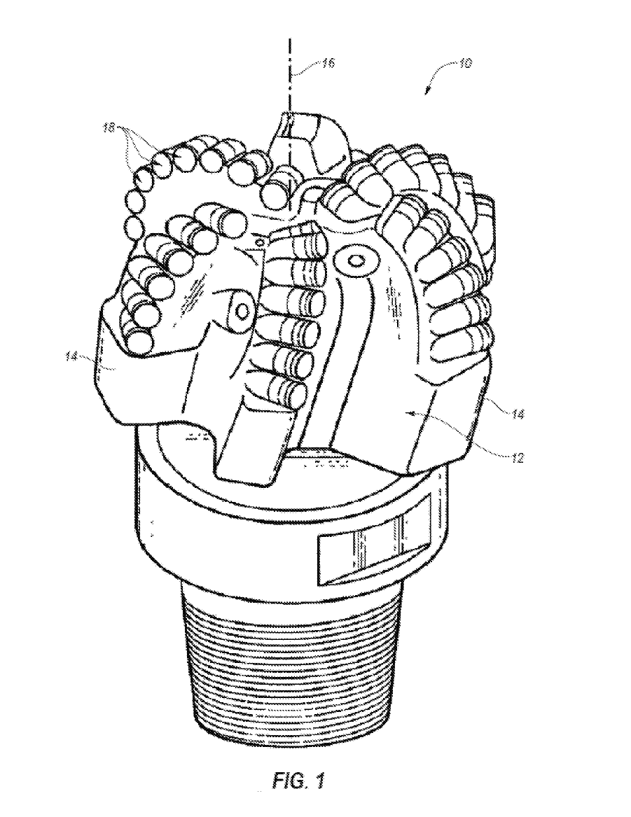

### DETAILED DESCRIPTION

In some instances, a HTHP process is used to bond the TSP to a tungsten carbide substrate. During the HTHP attachment process eruptions are often observed extending from the tungsten carbide substrate into the TSP layer. The eruptions are often composed of tungsten carbide grains and cobalt metal pools that precipitate and grow into the TSP layer during the HTHP attachment process. Eruptions may be at least an order of magnitude larger than conventional interstitial regions. The extension of the eruptions into the TSP layer and their relative size are unpredictable but often their presence is detrimental to the performance of the TSP tungsten carbide compact's wear and cutting performance.

Embodiments disclosed herein relate generally to methods and materials for reducing or eliminating the occurrence of eruptions during the attachment of a TSP layer to a substrate via HTHP processing. In particular, embodiments disclosed herein relate to the utilization of an eruption minimization material at an attachment interface surface of the TSP layer and/or the substrate to control eruptions during the attachment of a TSP layer to the substrate during HTHP processing. The use of embodiments disclosed herein may facilitate the formation of interfacial bonds between a TSP layer and a substrate that possess higher structural integrity and strength than interfacial bonds formed by methods which do not employ an eruption minimization material.

### Forming Polycrystalline Diamond

A polycrystalline diamond body may be formed in a conventional manner, such as by a high pressure, high temperature sintering of “green” particles to create intercrystalline bonding between the particles. “Sintering” may involve a high pressure, high temperature (HPHT) process. Briefly, to form the polycrystalline diamond body, an unsintered mass of diamond crystalline particles is placed within a metal enclosure of the reaction cell of a HPHT apparatus. A metal catalyst, such as cobalt or other Group VIII metals, may be included with the unsintered mass of crystalline particles to promote intercrystalline diamond-to-diamond bonding. The catalyst material may be provided in the form of powder and mixed with the diamond grains, or may be infiltrated into the diamond grains during HPHT sintering. An example minimum temperature is about 1200° C. and an example minimum pressure is about 3.55 GPa. Generally, processing may occur at a pressure ranging from about 4 to 7 GPa and temperatures ranging from about 1300° C. to 1600° C. Those of ordinary skill will appreciate that a variety of temperatures and pressures may be used, and the scope of the present disclosure is not limited to specifically referenced temperatures and pressures.

Diamond grains useful for forming a polycrystalline diamond body may include any type of diamond particle, including natural or synthetic diamond powders having a wide range of grain sizes. For example, such diamond powders may have an average grain size in the range from submicrometer in size to 100 micrometers, and from 1 to 80 micrometers in other embodiments. Further, one skilled in the art would appreciate that the diamond powder may include grains having a mono- or multi-modal distribution.

The diamond powder may be combined with the desired catalyst material, and the reaction cell is then placed under processing conditions sufficient to cause the intercrystalline bonding between the diamond particles. It should be noted that if too much additional non-diamond material is present in the powdered mass of crystalline particles, appreciable intercrystalline bonding may be prevented during the sintering process. Such a sintered material where appreciable intercrystalline bonding has not occurred is not within the definition of PCD. Following such formation of intercrystalline bonding, a polycrystalline diamond body may be formed that has, in one embodiment, at least about 80 percent by volume diamond, with the remaining balance of the interstitial regions between the diamond grains occupied by the catalyst material. In other embodiments, such diamond content may comprise at least 85 percent by volume of the formed diamond body, and at least 90 percent by volume in yet another embodiment. However, one skilled in the art would appreciate that other diamond densities may be used in other embodiments. Thus, the polycrystalline diamond bodies being leached in accordance with the present disclosure include what is frequently referred to in the art as “high density” polycrystalline diamond. One skilled in the art would appreciate that conventionally, as diamond density increases, the leaching time (and potential inability to effectively leach) similarly increases.

Further, one skilled in the art would appreciate that, frequently, a diamond layer is sintered to a carbide substrate by placing the diamond particles on a preformed substrate in the reaction cell and sintering. However the present disclosure is not so limited. Rather, the polycrystalline diamond bodies created in accordance with the present disclosure may or may not be attached to a substrate during their creation. In embodiments where the polycrystalline diamond bodies are attached to a substrate during their creation, the substrate may be removed to leave the formed polycyrystalline diamond by any methods known including the machining or grinding of the substrate.

In a particular embodiment, the polycrystalline diamond body is formed using solvent catalyst material provided as an infiltrant from a substrate, for example, a WC-Co substrate, during the HPHT process. In such embodiments where the polycrystalline diamond body is formed with a substrate, it may be desirable to remove the polycrystalline diamond portion from the substrate prior to leaching so that leaching agents may attack the diamond body in an unshielded manner, i.e, from each side of the diamond body without substantial restriction.

### Leaching Process

In various embodiments, a formed PCD body having a catalyst material in the interstitial spaces between bonded diamond grains is subjected to a leaching process whereby the catalyst material is at least partially removed from the PCD body. As used herein, the term “removed” refers to the reduced presence of catalyst material in the PCD body, and is understood to mean that a substantial portion of the catalyst material no longer resides in the PCD body. However, one skilled in the art would appreciate that while the PCD body may be substantially free of the catalyst material, trace amounts of catalyst material may still remain in the microstructure of the PCD body within the interstitial regions and/or adhered to the surface of the diamond grains.

The quantity of the catalyst material remaining in the material PCD microstructure after the PCD body has been subjected to a leaching treatment may vary, for example, on factors such as the treatment conditions, including treatment time. Further, one skilled in the art would appreciate that it may be desired in certain applications to allow a small amount of catalyst material to stay in the PCD body. In a particular embodiment, the PCD body may include up to 1-2 percent by weight of the catalyst material. However, one skilled in the art would appreciate that the amount of residual catalyst present in a leached PCD body may depend on the diamond density of the material, and body thickness.

As described above, a conventional leaching process involves the exposure of an object to be leached with a leaching agent. In select embodiments, the leaching agent may be a weak, strong, or mixtures of acids. In other embodiments, the leaching agent may be a caustic material such as NaOH or KOH. Suitable acids may include, for example, nitric acid, hydrofluoric acid, hydrochloric acid, sulfuric acid, phosphoric acid, or perchloric acid, as well as any organic acids (such as formic, lactic, oxalic, citric, or acetic acid), or combinations of these acids. In addition, other acidic and basic leaching agents may be used as desired. Those having ordinary skill in the art will appreciate that the molarity of the leaching agent may be adjusted depending on the time desired to leach, concerns about hazards, etc.

Additionally, in select embodiments, accelerating techniques may be applied to the leaching process to decrease the amount of treatment time to reach the same level of catalyst removal. In a particular embodiment, the leaching of a PCD body may be accelerated by subjecting the leaching environment and thus the PCD body to an elevated pressure. As used herein, the term “elevated pressure” refers to pressures greater than atmospheric pressure. Suitable pressure levels may include elevated pressure levels ranging from about 5 to 345 bar, and ranging from about 5 to 100 bar in another embodiment. However, one skilled in the art would appreciate that the particular pressure may be dependent, for example, on the particular equipment used, the temperature selected, amount (and type) of leaching agent present, and total system volume. Additionally, in one or more embodiments, the temperature of the leaching agent may be increased relative to ambient temperature during the leaching process to a temperature up to about the boiling point of the leaching solution. In yet another embodiment, the temperature of the leaching agent may be up to three times the boiling point of the leaching solution. Further, in one or more embodiments, the application of ultrasonic energy to accelerate the leaching process may be used. Ultrasonic energy is mechanical, vibratory energy in the form of sound that operates at frequencies beyond audible sound (18,000 cycles per second and greater). An ultrasonic stack is generally formed of a converter or piezoelectric transducer, an optional booster and a sonotrode (also called a horn). The use of ultrasonic energy can produce an 80 to 90 percent increase in leaching depth as a function of time as compared to leaching without using ultrasonic energy, thereby providing a desired decrease in leaching time and an improvement in manufacturing efficiency.

Once the leaching step is completed and the PCD body is removed from the leaching agent, the resulting material microstructure of the leached portion of the diamond body may include a first matrix phase of the bonded-together diamond grains and a second phase of a plurality of empty interstitial regions dispersed within the matrix phase. In other words, at the end of the leaching process, the treated interstitial regions may be substantially empty so that the second phase may be described as a plurality of voids or empty regions dispersed throughout the diamond-bonded matrix phase. Thus, the leached portion of the diamond body may be substantially free of the catalyst material used to initially form or sinter the diamond body, and may be referred to as thermally stable polycrystalline diamond (TSP).

### Attachment Process

In order to facilitate its use in equipment for drilling operations, the leached PCD body may be attached to a suitable substrate to form a cutting tool cutting element capable of being attached to a drill bit, cutting tool, or other end use application or device. However, once the catalyst material used to initially form the diamond body is removed from the diamond body, the remaining microstructure comprises a polycrystalline matrix phase with a plurality of interstitial voids forming what is essentially a porous material microstructure. The porous microstructure of the leached diamond body not only lacks mechanical strength, but also lacks a material constituent that is capable of forming a strong attachment bond with a substrate. In one or more embodiments, the attachment of the leached PCD body to a substrate may be performed using an infiltration process. Substrates useful in this regard can include substrates that are used to form conventional PCD, e.g., those formed from metals, ceramics, and/or cermet materials that contain a desired infiltrant. During an infiltration attachment process, the leached and thermally stable diamond body is subsequently treated so that the empty interstitial regions in one region comprise an infiltrant material, while the interstitial regions in another region remain empty or are substantially free of the infiltrant material. In particular embodiments, as the infiltrant material may originate from the substrate that is attached to the thermally stable diamond body, a region near the attachment interface surface may comprise an infiltrant material in the previously empty insterstitial regions of the thermally stable diamond body, while the interstitial regions in the thermally stable diamond body not near the attachment interface remain empty or are substantially free of the infiltrant material as a function from their distance from the attachment interface, i.e., interstitial regions that are farther away from the attachment interface surface have less of a probability of possessing infiltrant than interstitial regions that are closer to the attachment interface surface.

As used herein, the term “infiltrant material” is understood to refer to materials that are other than the catalyst material that was used to initially form the diamond body, and can include materials identified in Group VIII of the Periodic Table of the Elements that have subsequently been introduced into the sintered diamond body after the catalyst material used to form the same has been removed therefrom. In particular embodiments, the infiltrant material may be compositionally the same as the material that was used as the catalyst to form the PCD, which was then removed during the leaching process. In alternative embodiments, the infiltrant material may be compositionally different than the material that was used as the catalyst to form the PCD. Additionally, the term “infiltrant material” is not intended to be limiting on the particular method or technique use to introduce such material into the already formed diamond body.

In an example embodiment, the substrate is formed from WC-Co, which may be provided as a pre-sintered body or as a powdered layer. The substrate may be positioned adjacent the leached diamond body and the assembly is subjected to HPHT conditions sufficient to cause the cobalt in the substrate to melt and infiltrate into and fill the voids or pores in the polycrystalline diamond matrix thereby forming the attachment between the interface surfaces of the leached diamond body and the WC-Co substrate. A HPHT bonding process may include, for example, placing a leached diamond body and a substrate within a sealed can and subjecting the can and its contents to elevated pressures, such as greater than 5,000 MPa, and elevated temperatures, such as greater than 1,300° C. The HPHT bonding process may have different durations, temperatures, and pressures than the HPHT sintering step that is used to form PCD bodies.

Substrates of the present disclosure may include wear resistant material having hard particles dispersed in a binder metal matrix. An example substrate material may include tungsten carbide particles dispersed in a cobalt binder, such as cemented tungsten carbide and cobalt (WC/Co). Such substrate materials include a hard particle phase made of tungsten carbide particles and a metal binder phase made of cobalt. Tungsten carbide substrates may have, for example, a grain size ranging from about 6 microns or less (fine grain) in some embodiments, or greater than 6 microns (coarse grain) in other embodiments, and a binder content ranging from a lower limit selected from 6%, 8% and 10% by weight to an upper limit selected from 10%, 12%, 14% and 16% by weight.

As previously mentioned, the process of attaching a substrate to a leached diamond body via an infiltration process may lead to the precipitation of WC grains and infiltrant metal pools, hereinafter designated as eruptions, which can be detrimental to the formed composite's performance. FIG. 2 shows a visualization of an interface 200 between a carbide substrate 202 and an ultra-hard body (not shown so that interface can be seen). Interface 200 includes eruptions 204 from carbide substrate 202 that form during the attachment of a carbide substrate to a leached diamond body via an infiltration process. Eruptions 204 may form, for example, by the chemical reaction between diamond particles and the infiltration material. In an embodiment, the eruptions result from the following chemical reaction:

C+Co(W,C)=WC+Co,

where C is the diamond phase, and Co(W,C) is the infiltrated metal phase, which may be dissolved with W and C. The reaction leads to eruption volumes which consists of a majority of WC phase as well as Co. In an embodiment, the WC phase found in the eruptions is formed at the expense of diamond phase formation in this reaction. Increasing the rebonding pressure and/or temperature may promote the eruption formation.

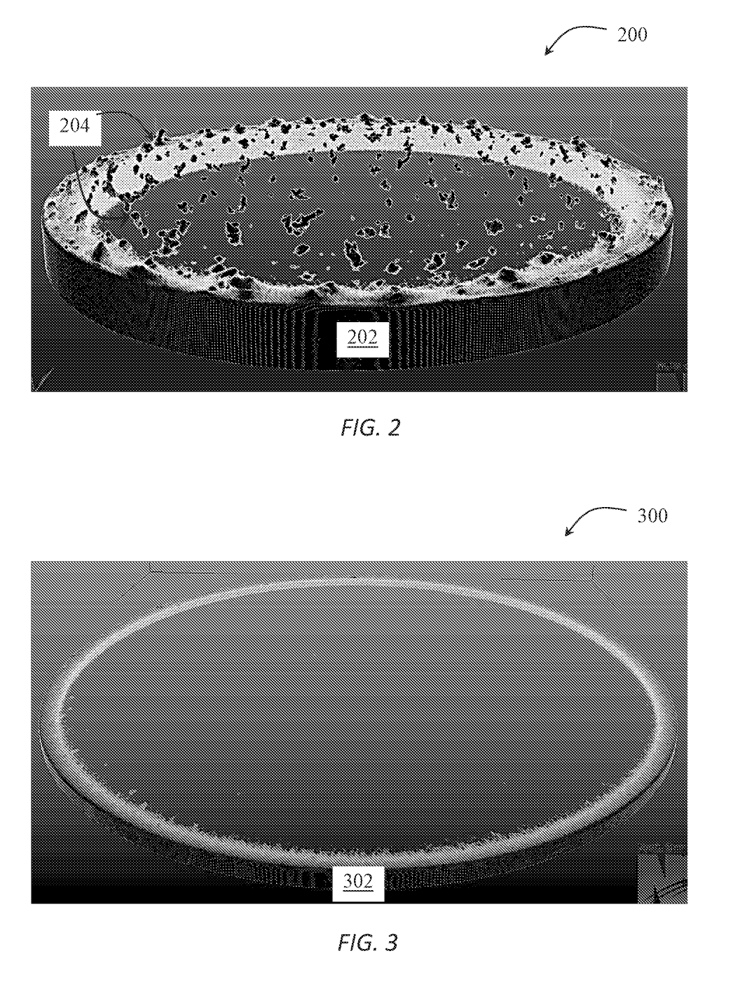

Applicants have found that by utilizing an eruption minimization material disposed on at least one interface surface of the substrate or the leached diamond body the amount of eruptions may be lowered and potentially eliminated. FIG. 3 shows a visualization of an interface 300 between a substrate 302 and an ultra-hard body (not shown so that the interface can be seen). In an embodiment, interface 300 has no eruptions in substrate 302. In an embodiment, substrate 302 has been coated by an eruption minimization material (not shown), such as TiC. In more general embodiments, the eruption minimization material may comprise a composition including at least one carbide, nitride, or carbonitride compound of an element from Group 4-6 of the Periodic Table of the Elements. In more particular embodiments, the eruption minimization material may include at least one compound from the group of TiC, Mo₂C, Cr₃C₂, WC, NbC, TaC, ZrC, VC and TiCN. In another embodiment, the eruption minimization material may include a refractory metal.

Further, eruptions may create a non-uniform microstructure in the diamond body. Particularly, eruptions formed using conventional methods of attaching a tungsten carbide substrate to a diamond body may include precipitated tungsten carbide grains and cobalt pools extending into the diamond body in a tree-shaped or branched pattern. Thus, the attached polycrystalline diamond body may have a microstructure including a plurality of bonded together diamond grains, a plurality of interstitial regions disposed among the bonded together diamond grains, and extensions of precipitated tungsten carbide grains and cobalt pools extending from the interface between the tungsten carbide substrate and diamond body a distance into the diamond body and through the bonded together diamond grains and interstitial regions. However, diamond compacts formed according to methods of the present disclosure may have an attached diamond body that is substantially free of eruptions. For example, an attached polycrystalline diamond body may have a substantially uniform microstructure including a plurality of bonded together diamond grains and a plurality of interstitial regions disposed among the bonded together diamond grains.

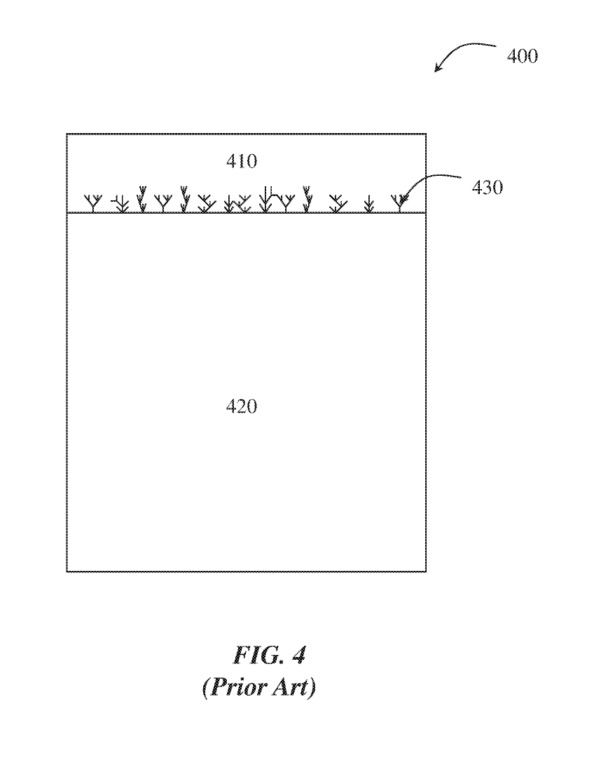

FIG. 4 shows an example of a diamond compact 400 formed by HPHT bonding of a diamond body 410 to a tungsten carbide substrate 420 without using an additive material (as described above). During the attaching step, eruptions 430 of tungsten carbide and cobalt precipitated from the substrate 420 into the diamond body 410 in a branched pattern. Eruptions 430 occurring from the HPHT bonding process of attaching a diamond body 410 to a tungsten carbide substrate 420 are distinct from substrate material that may infiltrate into the diamond body 410 during the HPHT bonding process. For example, as described above, eruptions 430 may be made of precipitated tungsten carbide and cobalt, which has a tree-like or dendrite form extending into the diamond body. During the HPHT bonding process, substrate material may also infiltrate into the diamond body. Infiltration occurs when the temperature of the HPHT bonding process reaches the melting temperature of the substrate material. For example, when the HPHT bonding process temperature reaches the melting point of cobalt, the cobalt from the tungsten carbide substrate may melt and infiltrate into the diamond body, thereby filling at least a portion of the interstitial regions. Further, prior to attachment to the substrate, the diamond body 410 may include bonded together diamond grains and substantially empty interstitial regions between the bonded together diamond grains. After the HPHT bonding process, the diamond body 410 may have an amount of infiltrated cobalt disposed within the interstitial regions, thereby reducing thermal stability.

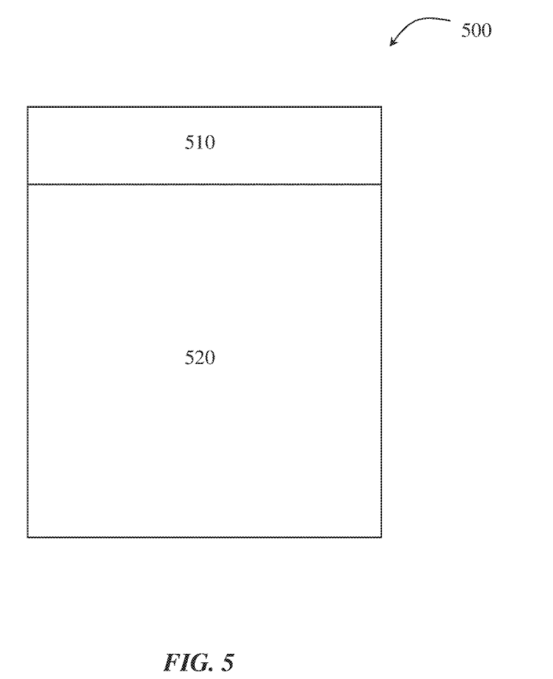

However, referring now to FIG. 5, eruptions may not occur when eruption minimization materials of the present disclosure are used to reattach a diamond body to a substrate to form a diamond compact. Particularly, FIG. 5 shows a diamond compact 500 formed by HPHT bonding of a thermally stable diamond body 510 to a tungsten carbide substrate 520, wherein an eruption minimization material of the present disclosure was applied to an attachment interface surface of the thermally stable diamond body 510 and/or the carbide substrate 520 prior to the HPHT bonding process. The final thermally stable diamond compact 500 (i.e., thermally stable diamond body bonded to a substrate) formed with an eruption minimization material may have a thermally stable diamond body microstructure made of a plurality of bonded together diamond grains and a plurality of interstitial regions between the bonded together diamond grains and is substantially free of eruptions. As described above, in some embodiments, cobalt from the substrate 520 may infiltrate into the thermally stable diamond body 510 during the HPHT bonding process. In such embodiments, the thermally stable diamond body may have infiltrated cobalt disposed within a plurality of the previously emptied interstitial regions. Further, in some embodiments, an amount of the eruption minimization material may infiltrate into the interstitial regions of the thermally stable diamond body from the substrate during the HPHT bonding process. For example, according to some embodiments, an eruption minimization material made of a transition carbide material other than tungsten carbide, such as chromium carbide, may be added to a tungsten carbide substrate, such as by providing the additive material at the attachment interface between the substrate and the thermally stable diamond body. During the HPHT bonding process, an amount of the eruption minimization material along with an amount of cobalt from the substrate may infiltrate into the thermally stable diamond body and may be disposed within at least a portion of the previously empty interstitial regions.

In one or more embodiments, the eruption minimization material may be disposed on an attachment interface surface of the leached diamond body and/or the substrate that it is to be attached to. In more particular embodiments, the eruption minimization material may be disposed on an attachment interface surface of the substrate only. The eruption minimization material may be disposed on an attachment interface surface by any known methods, although, sputter coating the eruption minimization material may be an effective method for applying the eruption minimization material. In some embodiments, the eruption minimization material may be coated onto an interface surface, for example, by applying a foil, applying a layer of powder, applying a layer of paste, casting, brushing, spraying, chemical vapor deposition (“CVD”), or physical vapor deposition (“PVD”) methods. In some embodiments, the eruption minimization material may be in the form of a powder composition that is disposed on at least on attachment interface surface by placing the powder composition adjacent the at least on attachment interface surface prior to the attachment of the other component (i.e., leached diamond body or substrate). In some embodiments, regardless of the application method, the thickness of the eruption minimization material disposed on at least one attachment interface surface may be from about 2 μm to 8 μm. In more particular embodiments, the thickness of the eruption minimization material disposed on at least one attachment interface surface may be from about 2 μm to 4 μm.

Although only a few example embodiments have been described in detail above, those skilled in the art will readily appreciate that many modifications are possible in the example embodiments without materially departing from this disclosure. Accordingly, all such modifications are intended to be included within the scope of this disclosure.

What is claimed is:

1. A method for making a polycrystalline diamond construction comprising:
subjecting diamond grains to a high pressure/high temperature condition in the presence of a catalyst material to form a polycrystalline diamond material comprising a matrix phase of bonded together diamond grains and interstitial regions disposed between the diamond grains including the catalyst material;
treating the polycrystalline diamond material to remove the catalyst material therefrom to form a diamond body that is substantially free of the catalyst material; and
attaching a substrate to the diamond body with a layer of eruption minimization material having a thickness from about 2 μm to 8 μm on at least one attachment interface surface of the substrate and/or diamond body.

2. The method of claim 1, wherein the eruption minimization material comprises a composition including at least one metal, carbide, nitride, or carbonitride compound of an element from Group 4-6 of the Periodic Table of the Elements.

3. The method of claim 1, wherein the eruption minimization material is disposed on the attachment interface surface of the substrate.

4. The method of claim 1, wherein the eruption minimization material is disposed on at least one attachment interface surface by one of sputter coating, application of a foil, application of a layer of powder, application of a layer of paste, casting, brushing, spraying, chemical vapor deposition, or physical vapor deposition.

5. The method of claim 1, wherein the thickness of the eruption minimization material disposed on at least one attachment interface surface is from about 2 μm to 4 μm.

6. The method of claim 1, wherein the polycrystalline diamond material is formed unattached to a substrate.

7. The method of claim 1, wherein the attaching comprises an infiltration process.

8. A polycrystalline diamond construction comprising:
a substrate;
a thermally stable diamond body with at least some of the interstitial regions within the diamond body and near an attachment interface with the substrate possessing an infiltrant that is not the catalyst material used to form the diamond body; and
a layer of eruption minimization material having a thickness from about 2 μm to 8 μm disposed at the attachment interface surface between the diamond body and the substrate.

9. The polycrystalline diamond construction of claim 8, wherein the eruption minimization material comprises a composition including at least one metal, carbide, nitride, or carbonitride compound of an element from Group 4-6 of the Periodic Table of the Elements.

10. The polycrystalline diamond construction of claim 8, wherein the thickness of the eruption minimization material is from about 2 μm to 4 μm.

11. A method for making a thermally stable polycrystalline diamond construction comprising:
disposing a layer of eruption minimization having a thickness from about 2 μm to 8 μm material on an attachment interface surface of either a substrate or a thermally stable diamond body that has had the catalyst material removed therefrom;
aligning the attachment interface surface of the substrate or the thermally stable diamond body to be adjacent to the attachment interface surface with the eruption minimization material disposed thereon; and
attaching the substrate to the thermally stable diamond body with a high temperature high pressure treatment.

12. The method of claim 11, wherein the eruption minimization material comprises a composition including at least one metal, carbide, nitride, or carbonitride compound of an element from Group 4-6 of the Periodic Table of the Elements.

13. The method of claim 11, wherein the eruption minimization material is disposed on the attachment interface surface of the substrate.

14. The method of claim 11, wherein the eruption minimization material is disposed on at least one attachment interface surface by one of sputter coating, application of a foil, application of a layer of powder, application of a layer of paste, casting, brushing, spraying, chemical vapor deposition, or physical vapor deposition.

15. The method of claim 11, wherein the thickness of the eruption minimization material disposed on at least one attachment interface surface is from about 2 μm to 4 μm.

16. The method of claim 11, wherein the attaching comprises an infiltration process.
